(19) United States
(12) Patent Application Publication
(10) Pub. No.: US 2017/0333843 A1
(43) Pub. Date: Nov. 23, 2017

(54) FUEL REFORMER

(71) Applicant: DENSO CORPORATION, Kariya-city, Aichi-pref. (JP)

(72) Inventors: Kenji AOYAGI, Kariya-city (JP); Yousuke NAKAGAWA, Kariya-city (JP)

(73) Assignee: DENSO CORPORATION, Kariya-city, Aichi-pref. (JP)

(21) Appl. No.: 15/533,741

(22) PCT Filed: Dec. 21, 2015
(86) PCT No.: PCT/JP2015/006356

§ 371 Date: Jun. 7, 2017

(30) Foreign Application Priority Data
Jan. 13, 2015 (JP) 2015-004426

(51) Int. Cl. B01D 53/94; F02M 27/02; F02D 19/06; B01J 10/00; C01B 3/38

(52) U.S. Cl. CPC B01D 53/94; B01J 10/007; C01B 3/384; F02D 19/0671; F02M 27/02; B01J 2219/0022; C01B 2203/0233; C01B 2203/0811; C01B 2203/1619; C01B 2203/84; C01B 2203/148

(57) ABSTRACT

A fuel reformer for producing a steam reforming reaction between fuel and water on a reforming catalyst includes a fuel injection part that injects and supplies fuel into the reforming catalyst, a temperature measurement part that measures a temperature of the reforming catalyst, and a determination part that determines whether a process for recovering the reforming catalyst is necessary. The determination by the determination part is made based on a temperature change of the reforming catalyst when the steam reforming reaction is produced.

### CROSS REFERENCE TO RELATED APPLICATION

This application is based on Japanese Patent Application No. 2015-4426 filed on Jan. 13, 2015, the disclosure of which is incorporated herein by reference.

### TECHNICAL FIELD

The present disclosure relates to a fuel reformer that causes a steam reforming reaction between fuel and water on a reforming catalyst.

### BACKGROUND ART

A vehicle having a fuel reformer has been proposed (e.g., Patent Document 1 below), and an intense effort is being made to advance development toward its practical use. The fuel reformer produces a reaction (steam reforming reaction) between water contained in exhaust gas discharged from an internal-combustion engine of the vehicle, and fuel such as ethanol, on a reforming catalyst to supply hydrogen obtained by this reaction to the internal-combustion engine.

Such a fuel reformer can recover the heat energy of exhaust gas by the steam reforming reaction, which is an endothermic reaction, and can convert the recovered heat energy into chemical energy such as hydrogen or carbon monoxide to reuse the heat energy. The use of fuel energy with high efficiency can restrain the fuel consumption amount of the vehicle.

It is known that the reforming catalyst deteriorates over time and the amount of hydrogen produced by the steam reforming reaction reduces gradually. This deterioration of the reforming catalyst is caused by, for example, carbon deposition on the catalyst surface or sulfur poisoning of the catalyst. To recover the deteriorated reforming catalyst thereby to restore the amount of hydrogen produced, the process (recovery process) needs to be performed for supplying oxygen to the reforming catalyst to remove carbon, sulfur and so forth.

In the fuel reformer described in Patent Document 1 below, a sensor is disposed on a downstream side of the reforming catalyst. The reformer determines a degree of deterioration of the reforming catalyst and necessity for the recovery process by detecting the components of gas after passing through the reforming catalyst (after the steam reforming reaction is caused) using this sensor,

### PRIOR ART DOCUMENT

### Patent Document

Patent Document 1: JP2009-144612A

However, it is not desirable due to the high cost of the fuel reformer to additionally dispose the sensor (e.g., H₂ sensor, O₂ sensor) for detecting the components of gas to determine the deterioration of the reforming catalyst and the necessity for the recovery process.

### SUMMARY OF INVENTION

The present disclosure addresses the above issues. Thus, it is an objective of the present disclosure to provide a fuel reformer that can determine deterioration of a reforming catalyst and necessity for a recovery process without providing a sensor for detecting components of gas.

To achieve the objective, a fuel reformer in an aspect of the present disclosure is for producing a steam reforming reaction between fuel and water on a reforming catalyst, and includes a fuel injection part that injects and supplies fuel into the reforming catalyst, a temperature measurement part that measures a temperature of the reforming catalyst, and a determination part that determines whether a process for recovering the reforming catalyst is necessary. The determination by the determination part is made based on a temperature change of the reforming catalyst when the steam reforming reaction is produced.

Since the steam reforming reaction is an endothermic reaction, the temperature of the reforming catalyst becomes lower as the reaction progresses. The temperature decrease amount in this case becomes larger as the amount of produced hydrogen becomes larger. In other words, the temperature decrease amount is larger as a degree of deterioration of the reforming catalyst is smaller, and the temperature decrease amount is smaller as the degree of deterioration of the reforming catalyst is larger.

The present disclosure is made by placing attention on this regard, and the above-configured fuel reformer determines whether the process for recovering the reforming catalyst is necessary based on the temperature change of the reforming catalyst while the steam reforming reaction is being produced. The fuel reformer can determine the deterioration of the reforming catalyst and the necessity for the recovery process based only on the temperature change of the reforming catalyst without providing a sensor for detecting components of gas.

This aspect can provide the fuel reformer that can determine the deterioration of the reforming catalyst and the necessity for the recovery process without providing the sensor for detecting the components of gas.

### BRIEF DESCRIPTION OF DRAWINGS

The above and other objects, features and advantages of the present disclosure will become more apparent from the following detailed description made with reference to the accompanying drawings. In the drawings:

FIG. 1 is a diagram schematically illustrating a configuration of a fuel reformer in accordance with an embodiment;

FIG. 2 is a flow chart showing a flow of processing performed by a control part of the fuel reformer illustrated in FIG. 1;

FIG. 3 is a graph showing a temperature change of a reforming catalyst according to the embodiment; and

FIG. 4 is a diagram showing a modification to the fuel reformer illustrated in FIG. 1.

### EMBODIMENT FOR CARRYING OUT INVENTION

An embodiment will be described below with reference to the accompanying drawings. To facilitate the understanding of explanation, the same reference numeral is given as far as possible to the same component in each drawing to omit repeated explanations.

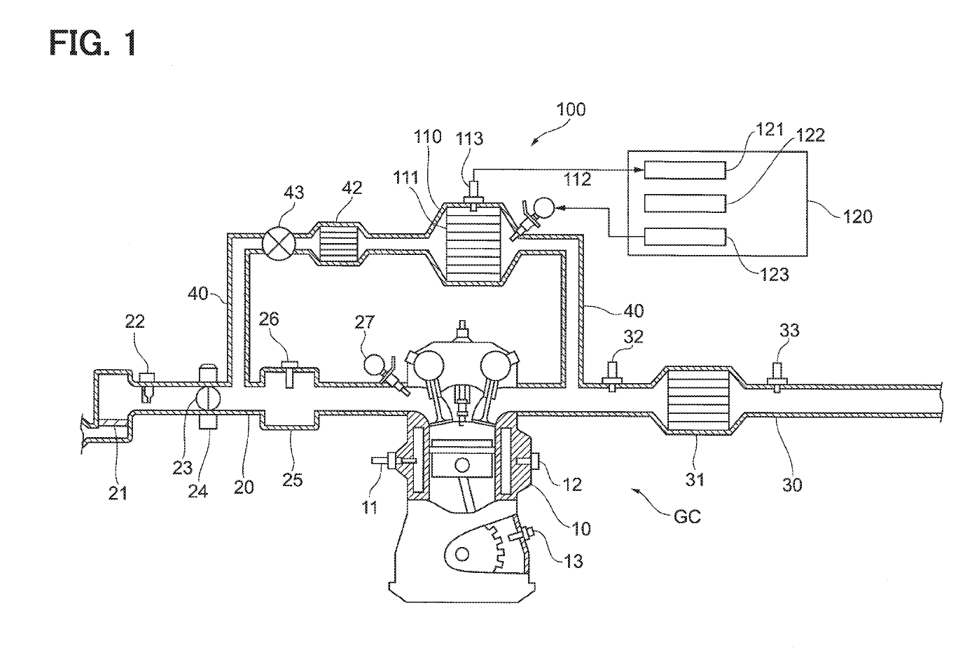

A fuel reformer 100 of the embodiment will be described with reference to FIG. 1. The fuel reformer 100 is attached to a part of a vehicle GC including an internal-combustion engine 10, and is a device for recovering and reusing the heat of exhaust gas discharged from the internal-combustion engine 10.

First, the configuration of the vehicle GC will be explained. The vehicle GC includes the internal-combustion engine 10, an intake pipe 20, an exhaust pipe 30, and an EGR pipe 40.

The internal-combustion engine 10 is a four-cycle reciprocating engine having cylinders, for generating driving force by combusting liquid fuel in the cylinders. The configuration of each cylinder is generally the same, and only a single cylinder is thus illustrated in FIG. 1 as the “internal-combustion engine 10”.

Various sensors such as a coolant temperature sensor 11, a knock sensor 12, and a crank angle sensor 13 are attached to each cylinder of the internal-combustion engine 10. The coolant temperature sensor 11 is a temperature sensor for measuring the temperature of coolant circulating between a radiator (not shown) and the internal-combustion engine 10. The knock sensor 12 is a sensor for detecting a knocking (abnormal combustion) caused in the cylinder of the internal-combustion engine 10. The crank angle sensor 13 is a sensor for measuring a rotation angle of a crankshaft of the cylinders. The measurement values obtained by these sensors are inputted into an ECU (not shown) that controls the entire vehicle GC,

The intake pipe 20 is a pipe for supplying air into the internal-combustion engine 10. An air cleaner 21, an air flow meter 22, a throttle valve 23, a surge tank 25. and a first injector 27 are provided for the intake pipe 20 in this order from the upstream side (left side in FIG. 1). The internal-combustion engine 10 is connected to the downstream end part (right side in FIG. 1) of the intake pipe 20.

The air cleaner 21 is a filter for removing foreign substances from the air, which is introduced from the outside of the vehicle GC. The air flow meter 22 is a flow meter for measuring a flow rate of air supplied into the internal-combustion engine 10 through the intake pipe 20. The flow rate measured by the air flow meter 22 is inputted into the ECU of the vehicle GC.

The throttle valve 23 is a flow regulation valve for regulating the flow rate of air through the intake pipe 20. In accordance with the operation amount of an accelerator pedal (not shown) of the vehicle GC, the opening degree of the throttle valve 23 is adjusted thereby to regulate the flow rate of air. The throttle valve 23 includes an opening degree sensor 24. The opening degree of the throttle valve 23 is measured by the opening degree sensor 24 and is inputted into the ECU of the vehicle GC.

The surge tank 25 is a box-shaped container that is formed at the intake pipe 20. The intake pipe 20 is divided into more than one branch on a downstream side of the surge tank 25. Each branched flow passage is connected to a corresponding cylinder. The internal space of the surge tank 25 is larger than the internal space of the other part of the intake pipe 20. The surge tank 25 prevents an influence of a pressure change by one cylinder on the other cylinders. The surge tank 25 includes a pressure sensor 26. The pressure in the intake pipe 20 is measured by the pressure sensor 26 and is inputted into the ECU of the vehicle GC.

The first injector 27 is an electromagnetic valve for injecting fuel into the intake pipe 20. The fuel pressurized by a fuel pump (not shown) is supplied to the first injector 27. When the first injector 27 is put into an open state, the fuel injected through the end of the injector 27 is mixed with air and supplied into the cylinder of the internal-combustion engine 10. The ECU of the vehicle GC controls the opening and closing operations of the first injector 27 to adjust the amount of fuel supplied to the internal-combustion engine 10.

The exhaust pipe 30 is a pipe for discharging exhaust gas, which is produced in the cylinder of the internal-combustion engine 10, to the outside. The upstream end part (left side in FIG. 1) of the exhaust pipe 30 is connected to the internal-combustion engine 10. A catalytic converter 31 for purifying exhaust gas is provided at the exhaust pipe 30 (downstream side of the internal-combustion engine 10).

An air-fuel ratio sensor 32 is provided at the part of the exhaust pipe 30 on an upstream side of the catalytic converter 31 and an oxygen sensor 33 is provided at the part of the exhaust pipe 30 on a downstream side of the catalytic converter 31. These are all sensors for monitoring the oxygen concentration of exhaust gas passing through the exhaust pipe 30, and their measurement results are inputted into the ECU of the vehicle GC. Based on the measurement results by the air-fuel ratio sensor 32 and so forth, the ECU controls, for example, the amount of fuel injected by the first injector 27 so that the combustion in the internal-combustion engine 10 is carried out at a theoretical air-fuel ratio.

The EGR pipe 40 is a pipe for returning a part of exhaust gas passing through the exhaust pipe 30 into the intake pipe 20 to supply the gas to the internal-combustion engine 10 again (for performing “exhaust gas recirculation”). The upstream end part of the EGR pipe 40 is connected to the position of the exhaust pipe 30 between the internal-combustion engine 10 and the catalytic converter 31. The downstream end part of the EGR pipe 40 is connected to the position of the intake pipe 20 between the throttle valve 23 and the surge tank 25.

An EGR cooler 42 and an EGR valve 43 are provided at the EGR pipe 40 in this order from the upstream side. A reforming unit part 110, which is a part of the fuel reformer 100, is provided at the part of the EGR pipe 40 on an upstream side of the EGR valve 43. The reforming unit part 110 will be described later.

The EGR cooler 42 is a cooler for cooling high-temperature exhaust gas to reduce its temperature beforehand, and then for supplying the gas to the intake pipe 20. The EGR valve 43 is a flow regulation valve for regulating the flow rate of exhaust gas passing through the EGR pipe 40. The ECU of the vehicle GC regulates the opening degree of the EGR valve 43 to adjust a rate of the exhaust gas flowing into the EGR pipe 40 to the exhaust gas passing through the exhaust pipe 30, i.e., an EGR rate.

The specific configuration of the vehicle GC is not limited to the above, and the fuel reformer of the present disclosure can be disposed in a variously-configured vehicle. For example, the connecting position of the EGR pipe 40 at the exhaust pipe 30 may be on a downstream side of the catalytic converter 31. The vehicle GC may include a supercharging device.

The configuration of the fuel reformer 100 will be described. The fuel reformer 100 includes the reforming unit part 110 and a control part 120. The reforming unit part 110 is provided at the part of the EGR pipe 40 on an upstream side of the EGR cooler 42 (exhaust pipe 30-side). The reforming unit part 110 includes therein a space leading to the EGR pipe 40, and is configured such that this space is filled with a reforming catalyst 111.

The reforming catalyst 111 is a “monolithic” catalyst that is formed from alumina. Grid-like flow passages are formed along the passage direction of the EGR pipe 40 at the reforming catalyst 111, and a catalyst material is supported on the inner wall surface of each flow passage.

A temperature sensor 113 for measuring a temperature of the reforming catalyst 111 is provided at the reforming unit part 110. The temperature of the reforming catalyst 111 is measured by the temperature sensor 113, and is inputted into the control part 120.

A second injector 112 is provided at the part of the reforming unit part 110 on an upstream side of the reforming catalyst 111. The second injector 112 is an electromagnetic valve configured similar to the first injector 27, which is provided for the internal-combustion engine 10, and can inject fuel (ethanol) into the space on an upstream side of the reforming catalyst 111. The opening/closing operation of the second injector 112, i.e., the fuel injection, is controlled by the control part 120, which will be described later.

The injection of fuel from the second injector 112 is carried out when EGR control is performed by the ECU of the vehicle GC, i.e., when the EGR valve 43 so is in an open state and exhaust gas passes through the EGR pipe 40. When fuel is injected by the second injector 112, the water contained in exhaust gas and the fuel are supplied into the reforming catalyst 111 in a mixed state in the reforming unit part 110.

The reforming catalyst 111 is heated by the exhaust gas passing through the reforming unit part 110 to have high temperature. When the water and fuel (hydrocarbon) come into contact with the high-temperature reforming catalyst 111, a steam reforming reaction is triggered between these to produce, for example, hydrogen and carbon monoxide.

The exhaust gas becomes hydrogen-containing gas by passing through the reforming unit part 110, and is supplied into the intake pipe 20. After that, the hydrogen-containing gas (exhaust gas) is supplied into the cylinder of the internal-combustion engine 10 for combustion again.

As is well-recognized, the steam reforming reaction produced in the reforming unit part 110 is an endothermic reaction, so that the exhaust gas is cooled to become the hydrogen-containing gas with its temperature lowered. Thus, the heat energy of exhaust gas is recovered by the steam reforming reaction in the reforming unit part 110, and is converted into chemical energy of hydrogen, carbon monoxide and so forth. The fuel reformer 100 recovers the heat energy of exhaust gas and converts it into the chemical energy, and then uses this chemical energy again in the internal-combustion engine 10 to improve the energy use efficiency of fuel. Such a fuel reformer 100 can improve the fuel efficiency of the vehicle GC.

The control part 120 is a computer system including a CPU, a ROM, a RAM, and an input/output interface. The control part 120 includes a temperature obtaining part 121, a determination part 122, and an injection control part 123 as functional control blocks.

The temperature obtaining part 121 is a part into which the signal from the temperature sensor 113 is inputted. Based on the signal inputted from the temperature sensor 113, the temperature obtaining part 121 obtains the temperature of the reforming catalyst 111.

The determination part 122 is a part that determines whether the process for recovering the reforming catalyst 111 is necessary. The reforming catalyst 111 deteriorates gradually because carbon deposition or sulfur poisoning is caused on the surface of the reforming catalyst 111 over time. As a consequence, the amount of hydrogen produced by the steam reforming reaction reduces gradually. The recovery process is carried out when the determination part 122 determines that the degree of this deterioration is great, i.e., that the performance of the reforming catalyst 111 needs to be recovered by performing the recovery process. The specific method for the determination will be described later.

The injection control part 123 is a part that controls the opening and closing operations of the second injector 112 by supplying a driving current to the second injector 112. The injection control part 123 controls the opening and closing operations of the second injector 112, such that the injection amount by the second injector 112 reaches a predetermined amount.

As described above, the signal from the temperature sensor 113 is inputted into the control part 120, and furthermore, a variety of information is inputted into the control part 120 through communication with the ECU (not shown) of the vehicle GC. For example, the opening degree of the EGR valve 43 or information such as operating conditions (e.g., the rotation speed or the load magnitude of the internal-combustion engine 10) of the vehicle GC is inputted into the control part 120 from the ECU of the vehicle GC. In addition, the control part 120 can change the operating state (e.g., air-fuel ratio) of the internal-combustion engine 10 through the communication with the ECU of the vehicle GC.

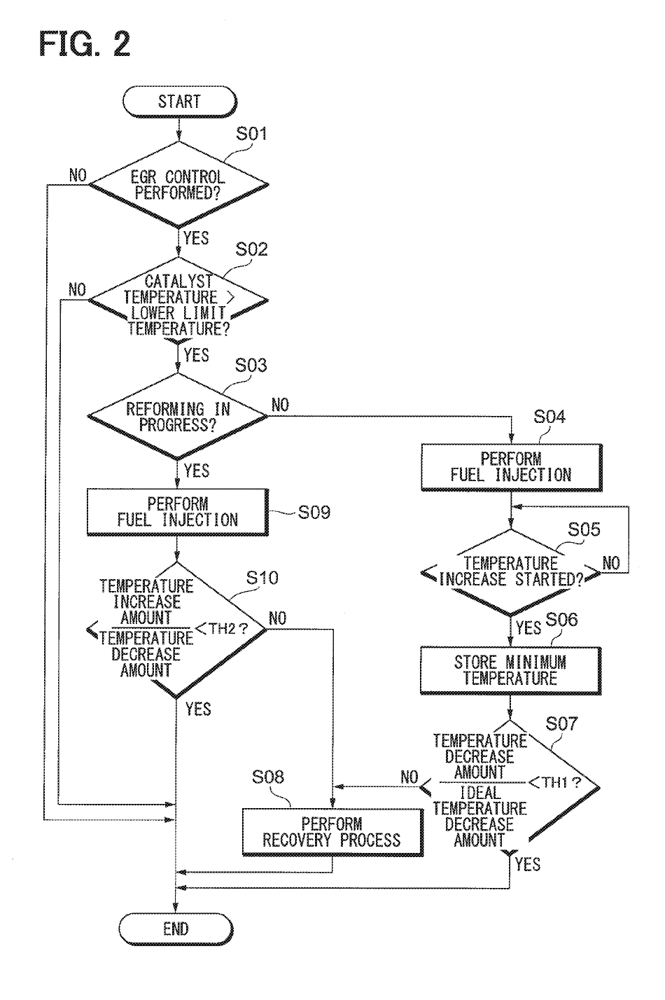

The specific content of processing performed by the control part 120 will be described with reference to the flow chart in FIG. 2. A series of processing illustrated in FIG. 2 is carried out repeatedly with a predetermined period.

At the first step S01, it is determined whether the EGR control is performed in the vehicle GC. If the EGR control is performed, i.e., if the EGR valve 43 is in an open state and exhaust gas passes through the EGR pipe 40, control proceeds to S02. If the EGR control is not performed, i.e., if the EGR valve 43 is in a closed state, the series of processing illustrated in FIG. 2 is ended.

At S02, it is determined whether the temperature of the reforming catalyst 111 measured by the temperature sensor 113 is higher than a preset lower limit temperature. The lower limit temperature is preset as the temperature that should be ensured at the minimum to sufficiently produce the steam reforming at the reforming catalyst 111 while the fuel reformer 100 is in operation. In the present embodiment, the value (e.g., 500° C.) that is equal to the catalyst active temperature is set as the lower limit temperature.

If the temperature of the reforming catalyst 111 is higher than the lower limit temperature, control proceeds to S03. If the temperature of the reforming catalyst 111 is equal to or lower than the lower limit temperature, this means that the temperature of the reforming catalyst 111 becomes lower than the lower limit temperature due to the fuel injection, and thus control ends the series of processing illustrated in FIG. 2.

It is determined at S03 whether the reforming process is performed, i.e., whether the injection of fuel from the second injector 112 is started. If the reforming process is not yet performed, control proceeds to S04. If the reforming process is already started, control proceeds to S09.

At S04, the injection of fuel from the second injector 112 is started. This starts to produce the steam reforming reaction in the reforming unit part 110. As previously mentioned, the temperature of the reforming catalyst 111 decreases since this reaction is an endothermic reaction.

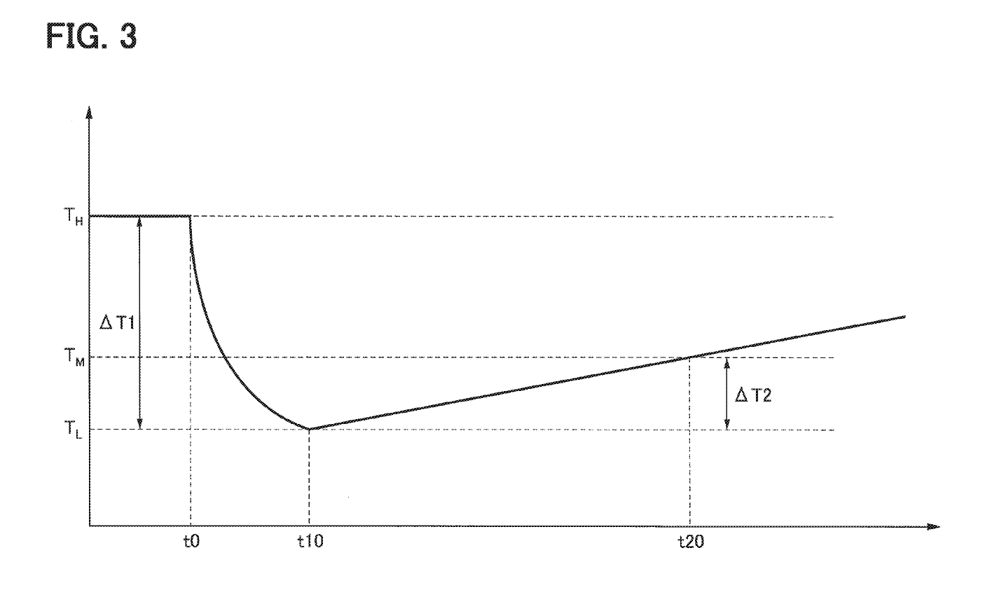

The temperature change of the reforming catalyst 111 after the injection of fuel from the second injector 112 is started will be explained with reference to FIG. 3. FIG. 3 illustrates one example of the temperature change of the reforming catalyst 111. As indicated by FIG. 3, when the injection of fuel from the second injector 112 is started at time t0, the temperature of the reforming catalyst 111 starts to decrease from its temperature T_{H} to reach the lowest temperature at time t10 (temperature at this time is hereinafter referred to as “minimum temperature T_{L}”).

A temperature decrease amount ΔT1 (value obtained by subtracting the minimum temperature T_{L} from the initial temperature T_{H}) is maximized when the deterioration of the reforming catalyst 111 is not caused at all. The above temperature decrease amount ΔT1 becomes smaller as the degree of the deterioration of the reforming catalyst 111 becomes greater. In the following description, the temperature decrease amount ΔT1 when the deterioration of the reforming catalyst 111 is not caused at all is also referred to as “ideal temperature decrease amount”.

After the temperature of the reforming catalyst 111 decreases to the minimum temperature T_{L}, the temperature of the reforming catalyst 111 increases gradually. At time t20 after the time t10 in the example illustrated in FIG. 3, the temperature of the reforming catalyst 111 increases from the minimum temperature T_{L} to temperature T_{M}.

Explanation is continued with reference back to FIG. 2. At the step S05 which follows the step S04, it is determined whether the temperature of the reforming catalyst 111 measured by the temperature sensor 113 starts to increase (after it has temporarily decreased). If the temperature of the reforming catalyst 111 does not start to increase, i.e., in a case before the time t10 in FIG. 3, the determination at S05 is repeatedly made. When it is detected that the temperature of the reforming catalyst 111 has started to increase, control proceeds to S06.

At S06, the measured minimum temperature T_{L} is stored in a storage device (not shown) of the control part 120.

At the step S07 which follows the step S06, the necessity to perform the recovery process for the reforming catalyst 111 is determined. Specifically, it is determined whether the value obtained by dividing the measured temperature decrease amount ΔT1 by the ideal temperature decrease amount (hereinafter also referred to as “temperature decrease rate”) is larger than a predetermined threshold value TH1. This determination is made at the determination part 122 of the control part 120.

If the temperature decrease rate is larger than the threshold value TH1, this means that the measured temperature decrease amount ΔT1 is relatively large and the degree of the deterioration of the reforming catalyst 111 is relatively small. Thus, the determination part 122 determines that it is unnecessary to perform the recovery process for the reforming catalyst 111. After that, the control part 120 ends the series of processing illustrated in FIG. 2.

If the temperature decrease rate (temperature decrease amount ΔT1/ideal temperature decrease amount) is equal to or lower than the threshold value TH1 at S07, this means that the measured temperature decrease amount ΔT1 is relatively small and the degree of the deterioration of the reforming catalyst 111 is relatively great. Thus, the determination part 122 determines that it is necessary to perform the recovery process for the reforming catalyst 111. In this case, control proceeds to S08.

At S08, the recovery process for the reforming catalyst 111 is performed. The recovery process of the present embodiment is a process for temporarily putting the air-fuel ratio of the internal-combustion engine 10 into a lean state (through the communication with the ECU of the vehicle GC). Since a larger amount of oxygen than usual reaches the reforming catalyst 111, carbon, sulfur and so forth covering the reforming catalyst 111 are eliminated through their reaction with oxygen. Consequently, the reforming performance of the reforming catalyst 111 is recovered to produce more steam reforming reactions. The recovery process may be performed by, for example, a temporary stop (fuel cut) of fuel supply to the cylinder of the internal-combustion engine 10. After executing the process at S08, control ends the series of processing illustrated in FIG. 2.

As above, in the present embodiment, the determination whether the process for recovering the reforming catalyst 111 is necessary is made based on the temperature change of the reforming catalyst 111 while the steam reforming reaction is being produced. Specifically, the determination is made based on the ratio (temperature decrease rate described above) between the ideal decrease amount that is preset as the temperature decrease amount when the reforming catalyst 111 is not deteriorated, and the actually-measured temperature decrease amount ΔT1.

This eliminates the need to separately provide a sensor for detecting the components of gas on a downstream side of the reforming catalyst 111, thereby reducing the cost of the fuel reformer 100.

Instead of the method of comparison between the temperature decrease rate and the threshold value TH1 as described above, another method may be used for the specific method for determining the necessity for the recovery process (degree of deterioration of the reforming catalyst 111).

For example, at S07, it may be determined whether the recovery process is performed based on whether the difference between the preset ideal decrease amount and the actually-measured temperature decrease amount ΔT1 is larger than a predetermined threshold value. In this case, if the calculated difference is larger than the threshold value, the degree of deterioration of the reforming catalyst 111 is estimated to be relatively great. Thus, control proceeds to S08 to perform the recovery process.

As yet another example, at S07, it may be determined whether the recovery process is performed based on whether the measured temperature decrease amount ΔT1 itself is larger than a predetermined threshold value. In this case, if the measured temperature decrease amount ΔT1 is smaller than the threshold value, the degree of deterioration of the reforming catalyst 111 is estimated to be relatively great. Thus, control proceeds to S08 to perform the recovery process.

If the reforming process is already performed at S03, i.e., if S03 is after the processing after S04 has been carried out and the injection of fuel from the second injector 112 has already been started, control proceeds to S09. The control proceeds to S09 after the time t10 that the temperature of the reforming catalyst 111 decreases to the minimum temperature T_{L}. At S09, the injection of fuel from the second injector 112 is continued.

At the step S10 which follows the step S09, the necessity to perform the recovery process for the reforming catalyst 111 is determined again. At S10, it is determined whether the value obtained by dividing a temperature increase amount ΔT2 by the measured temperature decrease amount ΔT1 (hereinafter also referred to as “temperature increase rate”) is smaller than a predetermined threshold value TH2. Similar to the determination at S07, this determination is made at the determination part 122 of the control part 120.

The “temperature increase amount ΔT2” used for the determination at S10 is a value obtained by subtracting the minimum temperature I_{L} that is stored at S06 from the temperature of the reforming catalyst 111 (increasing temperature) measured at the present time. Thus, the temperature increase amount ΔT2 is a value corresponding to the increase amount of the temperature of the reforming catalyst 111 after the time t10. As described above, this temperature increase is made due to the deterioration of the reforming catalyst 111, so that the value of the measured temperature increase amount ΔT2 becomes larger as the degree of deterioration becomes greater with the lapse of time.

At S10, if the temperature increase rate (temperature increase amount ΔT2/temperature decrease amount ΔT1) is smaller than the threshold value TH2, this means that the measured temperature increase amount ΔT2 is relatively small and the degree of the deterioration of the reforming catalyst 111 is relatively small. Thus, the determination part 122 determines that it is not yet necessary to perform the recovery process for the reforming catalyst 111. After that, the control part 120 ends the series of processing illustrated in FIG. 2.

At S10, if the temperature increase rate is equal to or higher than the threshold value TH2, this means that the measured temperature increase is amount ΔT2 is relatively large and the degree of the deterioration of the reforming catalyst 111 is relatively great. Thus, the determination part 122 determines that it is necessary to perform the recovery process for the reforming catalyst 111. In this case, control proceeds to S08. As described above, at S08, the recovery process for the reforming catalyst 111 is performed.

In this manner, the present embodiment also makes the determination whether the process for recovering the reforming catalyst 111 is necessary after the time t10 that the temperature of the reforming catalyst 111 starts to increase in accordance with the implementation of the reforming process. Specifically, the determination is made based on the ratio (temperature increase rate described above) between the temperature decrease amount ΔT1 taken for the temperature of the reforming catalyst 111 to become the lowest, and the temperature increase amount ΔT2 after the temperature of the reforming catalyst 111 becomes the lowest.

The determination (S10) based on the temperature increase rate is made again in addition to the determination (S07) based on the temperature decrease rate. Consequently, the necessity for the recovery process can be determined more reliably. Instead of both of these determinations, only one of these determinations may be made.

Other methods than the method of comparison between the temperature increase rate and the threshold value TH2, as described above, may be used for the specific method for determining the necessity for the recovery process (degree of deterioration of the reforming catalyst 111) based on the temperature increase rate.

For example, it may be determined at S10 whether the recovery process is performed based on whether the difference between the temperature decrease amount ΔT1 and the temperature increase amount ΔT2 is larger than a predetermined threshold value. In this case, if the calculated difference is smaller than the threshold value, the degree of deterioration of the reforming catalyst 111 is estimated to be relatively great. Thus, control proceeds to S08 to perform the recovery process.

The control part 120 may be provided as a separate device from the ECU of the vehicle GC as in the present embodiment, but may be provided integrally with the ECU of the vehicle GC. Thus, the ECU of the vehicle GC may be configured to serve also as the function of the control part 120.

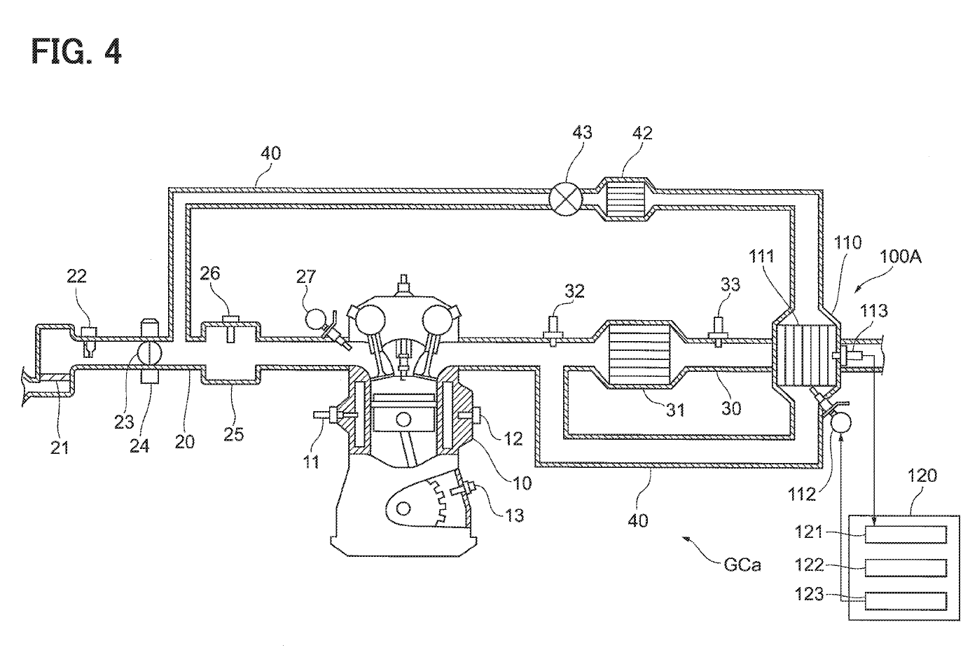

A modification to the present embodiment will be described with reference to FIG. 4. The configuration of a vehicle GCa illustrated in FIG. 4 is different only in position and structure of the reforming unit part 110 from the configuration of the vehicle GC.

In this modification, the reforming unit part 110 is provided at the part of the exhaust pipe 30 on a downstream side of the catalytic converter 31. The reforming catalyst 111 in the reforming unit part 110 is configured to be heated by the exhaust gas passing through the EGR pipe 40, and also to be heated by the exhaust gas passing through the exhaust pipe 30. Thus, the reforming unit part 110 is configured as a part of the heat exchanger to which both the EGR pipe 40 and the exhaust pipe 30 are connected.

Such a configuration can also maintain the temperature of the reforming catalyst 111 at a high temperature by the exhaust gas passing through the exhaust pipe 30. Thus, the steam reforming reaction at the reforming catalyst 111 can be produced more stably.

However, in such a configuration, the reforming unit part 110 grows in size and much of the limited space in the vehicle GC is taken by the reforming unit part 110. Furthermore, the temperature of the reforming catalyst 111 also changes by heating from the exhaust gas passing through the exhaust pipe 30, so that the accuracy of determination made by the determination part 122 based on the value measured by the temperature sensor 113 (determination whether the recovery process is performed) may be reduced.

In contrast, the fuel reformer 100 configured as illustrated in FIG. 1 has a structure whereby the reforming catalyst 111 is heated only by the exhaust gas passing through the EGR pipe 40 (flow passage in which the reforming catalyst 111 is disposed). This enables the downsizing of the reforming unit part 110, and can more accurately determine whether the recovery process is performed.

The embodiment has been described above with reference to the specific examples. However, the present disclosure is not limited to these specific examples. Thus, those obtained by making appropriate design changes to these specific examples by a person skilled in the art are also included in the scope of the present disclosure as long as they have the characteristics of the present disclosure. For example, the components of each of the above-described specific examples, and their arrangement, materials, conditions, shapes, and sizes are not limited to those illustrated, and can be modified appropriately. In addition, the components of each of the above-described embodiments can be combined as long as technically possible, and the combination of these is also included in the scope of the present disclosure as long as it has the characteristics of the present disclosure.

While the present disclosure has been described with reference to embodiments thereof, it is to be understood that the disclosure is not limited to the embodiments and constructions. The present disclosure is intended to cover various modification and equivalent arrangements. In addition, the various combinations and configurations, other combinations and configurations, including more, less or only a single element, are also within the spirit and scope of the present disclosure.

1. A fuel reformer for producing a steam reforming reaction between fuel and water on a reforming catalyst, the fuel reformer comprising:
a fuel injection part that injects and supplies fuel into the reforming catalyst;
a temperature measurement part that measures a temperature of the reforming catalyst; and
a determination part that determines whether a process for recovering the reforming catalyst is necessary, wherein the determination by the determination part is made based on a temperature change of the reforming catalyst when the steam reforming reaction is produced.

2. The fuel reformer according to claim 1, wherein the determination by the determination part is made based on a temperature decrease amount of the reforming catalyst when fuel starts to be injected into the reforming catalyst.

3. The fuel reformer according to claim 2, wherein the determination by the determination part is made based on a difference or a ratio between an ideal decrease amount that is preset as the temperature decrease amount when the reforming catalyst is not deteriorated, and the temperature decrease amount that is actually measured.

4. The fuel reformer according to claim 2, wherein the determination by the determination part is made based on whether the temperature decrease amount is smaller than a preset threshold value.

5. The fuel reformer according to claim 1, wherein the determination by the determination part is made based on a temperature increase amount of the reforming catalyst after the temperature of the reforming catalyst becomes the lowest when the steam reforming reaction is produced.

6. The fuel reformer according to claim 5, wherein the determination by the determination part is made based on a difference or a ratio between a temperature decrease amount of the reforming catalyst when fuel starts to be injected into the reforming catalyst, and the temperature increase amount.

7. The fuel reformer according to claim 1, wherein:
the reforming catalyst is disposed in an exhaust gas recirculation flow passage, through which exhaust gas discharged from an internal combustion engine of a vehicle passes; and
the reforming catalyst is heated only by the exhaust gas passing through the exhaust gas recirculation flow passage.
